(19) United States
(12) Patent Application Publication
(10) Pub. No.: US 2026/0280371 A1
(43) Pub. Date: Sep. 17, 2026

(54) ROTOR DESIGN FOR OIL COOLING SPLIT

(71) Applicant: Rivian IP Holdings, LLC, Irvine, CA (US)

(72) Inventors: Shreyas Kapatral, Fullerton, CA (US); Sai Saagar Adimulam, Valencia, CA (US)

(21) Appl. No.: 19/076,735

(22) Filed: Mar. 11, 2025

(51) Int. Cl. H02K 1/32

(52) U.S. Cl. CPC H02K 1/32

(57) ABSTRACT

An end ring of a rotor is configured to distribute fluid in the rotor. The end ring includes a catch basin configured to receive fluid from a rotor shaft, an inner annulus extending in opposite directions from the catch basin, and a pair of grooves extending radially outward from the inner annulus. The catch basin is located between the pair of grooves, and when the end ring is rotating, the inner annulus is configured to receive the fluid from the catch basin and direct the fluid to the pair of grooves.

### INTRODUCTION

The present disclosure is directed to rotor cooling designs and, more particularly, rotor end rings having catch basins to split flow more evenly to cool magnets of a rotor.

### SUMMARY

In some embodiments, the present disclosure is directed to an end ring for distributing fluid in a rotor. In some embodiments, the end ring includes a catch basin configured to receive fluid from a rotor shaft, an inner annulus extending in opposite directions from the catch basin, and a pair of grooves extending radially outward from the inner annulus. In some embodiments, the catch basin is located between the pair of grooves and, when the end ring is rotating, the inner annulus is configured to receive the fluid from the catch basin and direct the fluid to the pair of grooves. In some embodiments, the end ring includes N sectors arranged about a center axis, the catch basin is arranged in one sector of the N sectors, and the pair of grooves is arranged in the one sector and centered about the catch basin. In some such embodiment, the end ring includes N catch basins, of which the catch basin is one. For example, in some embodiments, the end ring includes four quadrants arranged about a center axis, the catch basin is arranged in one quadrant of the four quadrants, and the pair of grooves is arranged in the one quadrant and centered about the catch basin. In some embodiments, for example, the end ring has a ring shape, where the inner annulus is arranged at a radially inward portion of the end ring extending around the rotor shaft, and the catch basin has a volume extending radially outward from the inner annulus. In some embodiments, for example, the end ring has a main body having a ring shape, where the inner annulus is arranged at a radially inward portion of the main body around the rotor shaft, and the catch basin has a volume recessed in the main body radially outward from the inner annulus. For example, a plurality of catch basins may extend radially outward from the inner annulus, creating pockets azimuthally along the inner annulus. In some embodiments, the catch basin is configured to distribute a first portion of the fluid in a first azimuthal direction along the inner annulus to a first groove of the pair of grooves, and distribute a second portion of the fluid in a second azimuthal direction, opposite the first direction, along the inner annulus to a second groove of the pair of grooves.

In some embodiments, the end ring includes a pair of ports, each coupled to a respective groove of the pair of grooves, that are configured to direct the fluid from the pair of grooves axially to cooling passages of the rotor. For example, in some embodiments, the fluid is a first stream, and the end ring further includes an outlet port extending axially through the end ring and are configured to direct a second stream from the cooling passages and out of the rotor.

In some embodiments, the present disclosure is directed to an end ring for a rotor, and includes a plurality of catch basins each having a respective volume extending radially outward from an inner annular surface. In some such embodiments, each respective catch basin is configured to receive a fluid in the respective volume, direct a first portion of the fluid in a first azimuthal direction along the inner annular surface, and direct a second portion of the fluid in a second azimuthal direction along the inner annular surface, opposite the first azimuthal direction. In some embodiments, the first azimuthal direction corresponds to a direction of rotation of the end ring. In some embodiments, the end ring includes a plurality of grooves recessed in a surface of the end ring that extend radially outward from the inner annular surface, and each respective catch basin of the plurality of catch basins is arranged between two respective grooves of the plurality of grooves. In some embodiments, each catch basin of the plurality of catch basins is configured to receive a respective portion of the fluid from a rotor shaft and split the respective portion among the two respective grooves. For example, in some embodiments, the plurality of catch basins includes N catch basins, with N is being greater than two, and the plurality of grooves includes 2N grooves. In some embodiments, the end ring has a ring shape having a radially inward end and a radially outward end, and the inner annular surface is arranged at the radially inward end.

In some embodiments, the end ring includes a plurality of ports each coupled to a respective groove of the plurality of grooves and configured to direct a respective portion of the fluid from the respective groove to a cooling passage of the rotor. For example, in some embodiments, the fluid is a first stream, and the end ring includes a plurality of outlet ports extending axially through the end ring and configured to direct a second stream from cooling passages of the rotor out of the rotor. In some embodiments, the end ring includes four quadrants arranged about a center axis, the plurality of catch basins has four catch basins, and each catch basin of the four catch basins is arranged in a respective quadrant.

In some embodiments, the present disclosure is directed to a rotor having a rotor shaft and an end ring. In some embodiments, the rotor shaft includes a feed port arranged in an outer surface, and the end ring extends around the rotor shaft. In some embodiments, the end ring includes a catch basin configured to receive fluid from the feed port, an inner annulus extending in opposite directions from the catch basin, and a pair of grooves extending radially outward from the inner annulus. In some such embodiments, the catch basin is located between the pair of grooves and, when the rotor is rotating, the inner annulus is configured to receive the fluid from the catch basin and direct the fluid to the pair of grooves. In some embodiments, the end ring includes a ring shape, the inner annulus is arranged at a radially inward portion of the end ring extending around the rotor shaft, and the catch basin has a volume extending radially outward from the inner annulus. In some embodiments, the end ring has N sectors arranged about a center axis, the catch basin is arranged in one sector, and the pair of grooves is arranged in the one sector and centered about the catch basin. For example, in some embodiments, an end ring has four quadrants arranged about a center axis, the catch basin is arranged in one quadrant of the four quadrants, and the pair of grooves is arranged in the one quadrant and centered about the catch basin.

In some embodiments, the end ring is a first end ring arranged at a first axial end of the rotor, and the rotor includes a second end ring identical to the first end ring and arranged at a second axial end of the rotor, opposite to the first axial end. In some such embodiments, the first end ring is configured to provide the fluid to cooling passages of the rotor, and the second end ring is configured to receive the fluid from the cooling passages. In some embodiments, where the end ring includes N sectors with N catch basins, the second end ring is clocked 180/N degrees relative to the first end ring. In some embodiments, the rotor includes M magnet pole-pairs where M is an even integer, the first end ring includes M/2 sectors of which the catch basin is arranged in a first sector, and the second end ring is clocked 360/M degrees relative to the first end ring.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

FIG. 1 shows a block diagram of an illustrative electric motor having an end ring that includes catch basins and an inner annulus, in accordance with some embodiments of the present disclosure;

FIGS. 2-3 shows a perspective view of an illustrative rotor having end rings, in accordance with some embodiments of the present disclosure;

FIG. 4 shows a side view of an illustrative end ring of the rotor of FIGS. 2-3, in accordance with some embodiments of the present disclosure;

FIGS. 5-6 show perspective views of a sector of the illustrative end ring of FIG. 4, in accordance with some embodiments of the present disclosure;

FIG. 7 shows a perspective view of illustrative flow paths in a rotor, in accordance with some embodiments of the present disclosure;

FIG. 8 shows a cross-sectional view of an illustrative catch basin of an end ring, and a flow path, in accordance with some embodiments of the present disclosure; and

FIG. 9 is a flowchart of an illustrative process for directing flow in a rotor, in accordance with some embodiments of the present disclosure.

### DETAILED DESCRIPTION

In some embodiments, the present disclosure is directed to an end ring design of a rotor, of an electric motor, that provides cooling fluid such as oil to magnet pockets of the rotor. Because the end ring design provides a more even split of the flow, lower grade magnets may be used because the magnet temperatures are more equal (e.g., the maximum temperature is reduced). In order to achieve this more even split, for example, the end rings of the present disclosure include catch cans, or catch basins, that direct the oil as it flows from holes (e.g., feed ports) in the rotor shaft. The catch cans direct the oil along an inner annulus in both directions (e.g., in the direction of rotation and against rotation), allowing the more even split. The oil flows along the inner annulus to grooves on either side of the catch can that extend radially outward to cooling passages in the rotor substacks. The oil then flows through the cooling passages and out of ports in a second identical end ring at an axially opposite end of the rotor. The two end rings are clocked such that each directs oil in opposing axial directions in respective cooling passages. In an illustrative example, the present disclosure may be applied to direct-oil-cooling of the magnets of a rotor, where the oil in the passages comes in contact with the magnets without any intervening material in-between.

In an illustrative example, an end ring may include N sectors, each centered about a hole in the rotor shaft, and with each of N catch cans aligned with a respective hole. Additionally, N pairs of grooves are arranged on either side of each of the respective catch cans. Accordingly, each end ring supplies cooling oil to 2N passages. Each end ring also includes 2N outlet ports, which are though holes that allow the oil to exit the rotor and flow radially outward from the rotor. For example, N may be 4, 6, 8, or any other suitable positive integer.

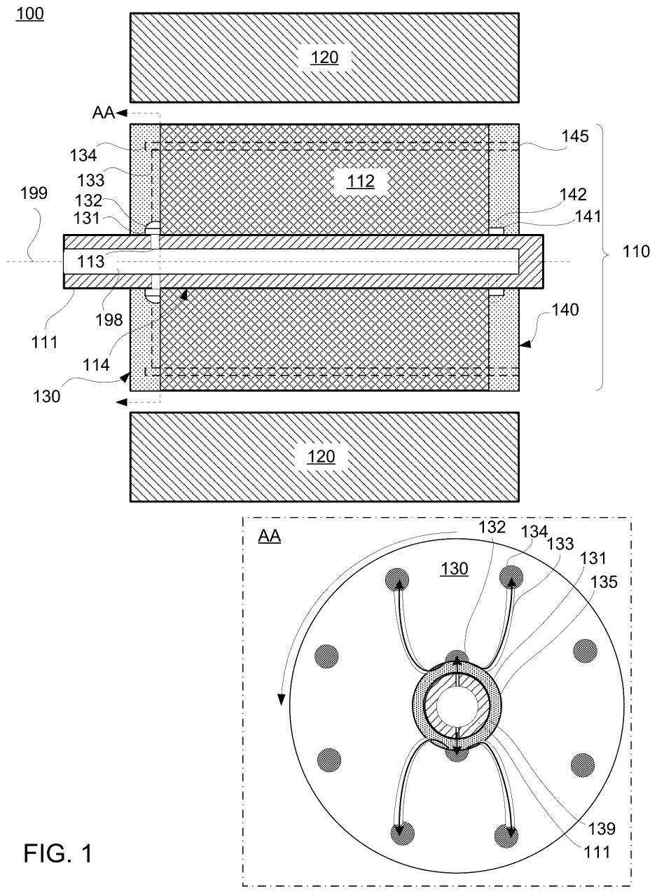

FIG. 1 shows a block diagram of illustrative electric motor 100 having rotor 110 having end ring 130 that includes catch basins 132 and inner annulus 131, in accordance with some embodiments of the present disclosure. As illustrated, electric motor 100 includes stator 120 and rotor 110, which includes shaft 111 with recess 198, and body 112 with cooling passages 134 (e.g., channels). As illustrated, rotor 110 is configured to rotate about axis 199, which defines the axial direction. In some embodiments, as illustrated in FIG. 1, rotor 110 includes common end plates at each axial end of body 112 (e.g., end rings 130 and 140). In some embodiments, rotor 110 is an interior permanent magnet (IPM) rotor, in which rotor losses may translate to heat, which can have an impact on permanent magnet performance. Accordingly, balanced rotor cooling is critical to operation of a motor (e.g., an IPM motor), and more equal magnet temperatures may allow for lower grade magnets to be used.

In order to achieve more even cooling in rotor 110, a fluid (e.g., liquid lubricant such as oil) is provided to cooling passages 134 (e.g., and other suitable passages not illustrated in FIG. 1). The fluid is provided to recess 198 of shaft 111 (e.g., recess 198 may be a blind hole and shaft 111 may be hollow). As the relatively cool fluid enters recess 198 (e.g., of the hollow rotor shaft, as illustrated), the fluid then flows to feed ports 113 of rotor 110. For example, feed ports 113 may include holes in shaft 111 that extend radially outward from recess 198 to outer surface 114 of shaft 111. The fluid flows out of each of feed ports 113 and impinges on a respective catch basin of catch basins 132 (also referred to as a “catch can”), which acts as a basin for the fluid. The fluid in catch basins 132 is then directed along inner annulus 131 (e.g., along surface 135 of inner annulus 131 that faces radially inward) in both directions (e.g., into and out of the page, with and against the direction of rotation). To illustrate, end ring 130 includes inner surface 139 configured to interface to outer surface 114 of shaft 111. Surface 135 is radially outward of inner surface 139, with their radial difference defining the thickness of inner annulus 131. Inner annulus 131 does not extend axially through the thickness of end ring 130 and covers an axial length corresponding to, for example, the thickness of end ring 130 minus the axial thickness of inner surface 139. For each catch basin of catch basins 132, a pair of grooves are arranged with one groove on each side of the respective catch basin (e.g., the grooves are azimuthally offset in each direction from the respective catch basin). Accordingly, as the fluid flows from the respective catch basin and along inner annulus 131, a first portion of the fluid enters one groove, and the remaining portion enters the other groove. The fluid flows along the pair of grooves to a pair of cooling passages of cooling passages 134 and then axially along the pair of cooling passages to the other end ring (e.g., end ring 140). The fluid then exits rotor 110 by flowing through ports 145 of the other end ring (e.g., end ring 140). In some embodiments, end ring 140 is identical to end ring 130, and includes inner annulus 141 and catch basins 142 (e.g., cooling passages corresponding to catch basins 142 are not illustrated in FIG. 1). Catch basins 142 may be clocked any suitable angle from catch basins 132 (e.g., and thus may be azimuthally offset), and are arranged azimuthally about axis 199 (e.g., in an equally spaced pattern or other suitable arrangement).

To illustrate, the fluid may flow from end faces of end rings 130 and 140 radially outward to stator 120 and then return to a basin for recirculation in the fluid system (e.g., to re-enter recess 198 and repeat heat transfer in a continuous flow).

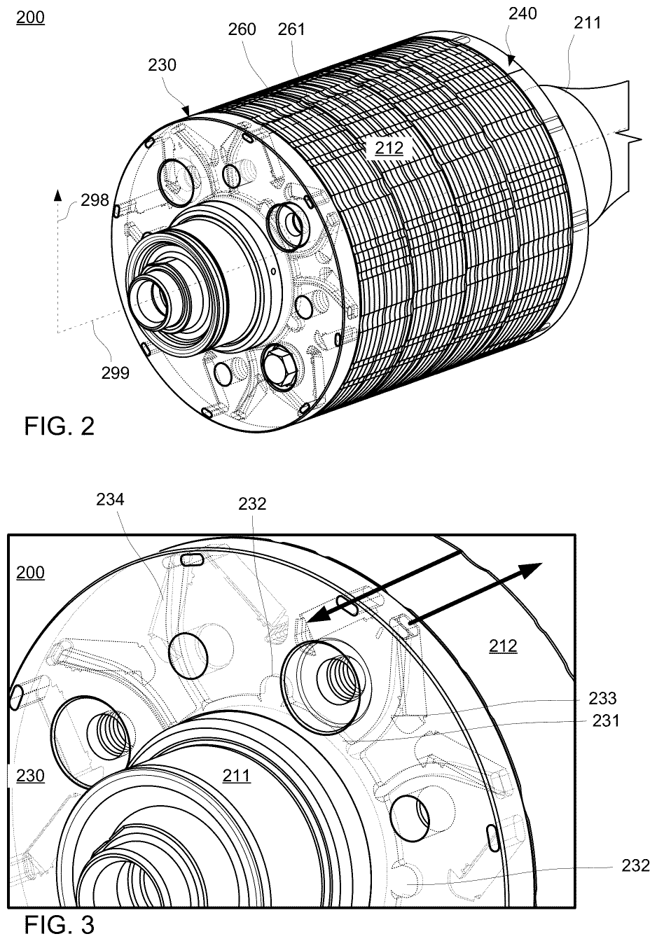

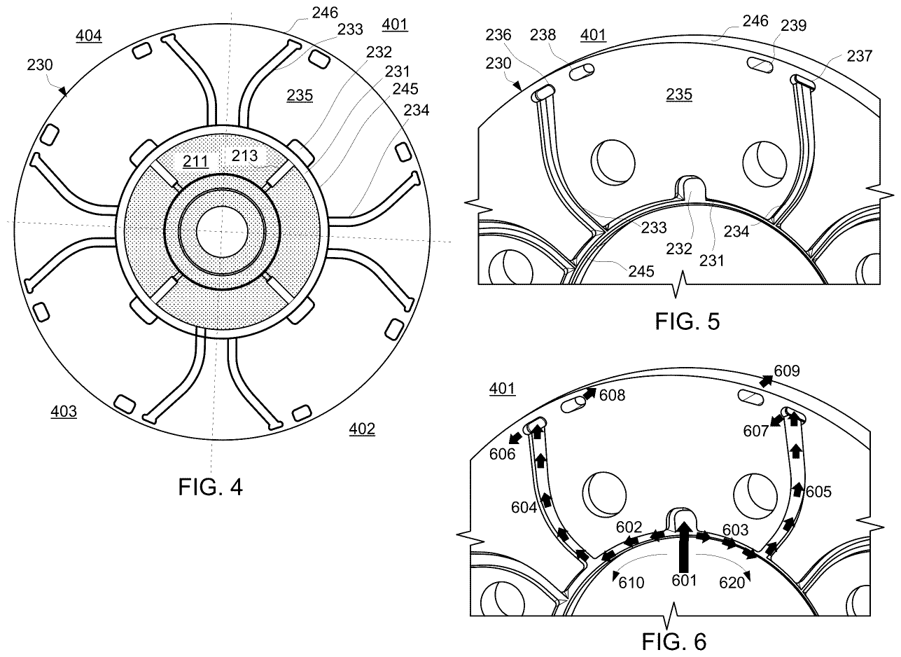

FIGS. 2-3 shows a perspective view of illustrative rotor 200 having end rings 230 and 240, in accordance with some embodiments of the present disclosure. FIG. 4 shows a side view of illustrative end ring 230 of FIGS. 2-3 (e.g., facing an axial face of end ring 230), in accordance with some embodiments of the present disclosure. FIGS. 5-6 show perspective views of a sector of illustrative end ring 230 of FIG. 4 (e.g., corresponding to sector 401), in accordance with some embodiments of the present disclosure. FIG. 5 includes an enlargement of the sector, while FIG. 6 illustrates flow paths of streams of the fluid. As illustrated, end ring 230 includes sectors 401, 402, 403, and 404 (e.g., four quadrants, as illustrated) arranged about the center (e.g., aligned with axis 299 in FIG. 2). All of sectors 401-404 have similar features as each other, so only those of sector 401 are labeled in FIG. 4 for ease of reference. Some of the features illustrated in FIGS. 2-6 include:
211: Rotor Shaft
212: Substacks
213: Feed Port
230, 240: End Rings
231: Inner Annulus
232: Catch Basin (i.e., Catch Can)
233-234: Grooves (i.e., Spider Grooves)
235: End Ring Main Body
236-237: Inlet Ports
238-239: Outlet Ports
260, 261: Cooling Passages
401-404: Sectors
601-605: Streams
610: First Azimuthal Direction
620: Second Azimuthal Direction

As illustrated in FIGS. 2-3, rotor 200 includes two end rings, end rings 230 and 240, arranged at opposite axial ends. For example, end ring 230 may be arranged at a first axial end of rotor 200 and end ring 240 may be arranged at a second axial end opposite the first axial end. The axial ends may correspond to the bounds of the substacks 212 of rotor 200, and end rings 230 may face each other. Rotor shaft 211 may extend beyond the axial ends of rotor 200, for example, to interface to bearings, gearing, seals, or other suitable components. In some embodiments, end rings 230 and 240 are identical, and are arranged such that they are flipped 180° about axis 298 such that corresponding identical faces are directed axially inward toward each other. In some such embodiments, end ring 240 is clocked 360°/(2N) where N is the number of catch basins (e.g., if N is equal to 4, then end ring 240 is clocked 360°/8 or 45°).

Fluid is provided to rotor shaft 211 and flows through feed port 213, which may include a through hole, as illustrated by stream 601 in FIG. 6. For example, a fraction of the total flow into end ring 230 equal to about one fourth may flow through feed port 213 (e.g., stream 601). The fluid flows from feed port 213 to catch basin 232. The fluid then flows from catch basin 232 along inner annulus 231 in both first and second azimuthal directions 610 and 620 (e.g., toward groove 233 in one direction and toward groove 234 in the other direction), as illustrated by streams 602 and 603. In some embodiments, the flow split from catch basin 232 to grooves 233 and 234 is equal or about equal (e.g., a 50-50 split of the flow into catch basin 232). In some embodiments, the flow split from catch basin 232 to grooves 233 and 234 is between 50-50 and 60-40 (e.g., with slightly more flow in the direction opposite to rotation of rotor shaft 211). For example, because the rotor may spin in either direction during operation, without catch basin 232 the flow may preferentially flow in a direction opposite the direction of rotation (e.g., relative to the rotor). Catch basin 232 may help to lessen this imbalance. For example, the more balanced the flow split (e.g., the closer to a 50-50 split), the more even cooling that may be achieved in the rotor. In some embodiments, the flow rate may be tuned based on the design of the catch basin shape (e.g., asymmetrical design, depth-width-length dimensions, volume), sizing or path of grooves 233, sizing or arrangement of ports, modifying any other suitable dimension or shape, or any combination thereof. After entering catch basin 232, streams 602 and 603 then flow from inner annulus 231 to respective grooves 233 (e.g., stream 604) and 234 (e.g., stream 605). Stream 604 then flows into inlet port 236, and stream 605 flows into inlet port 237, feeding respective streams 606 and 607 into respective cooling passages (e.g., out of the page, as illustrated in FIG. 6). Counter streams from the other end ring (e.g., end ring 240, not shown in FIGS. 4-6), flow out of outlet ports 238 and 239, illustrated by streams 608 and 609 (e.g., out of the page as illustrated, each corresponding to a stream from adjacent sectors of end ring 240, which is clocked 45 degrees from end ring 230). Referencing FIG. 6, each catch basin (e.g., catch basin 232) may be configured to distribute a first portion of the fluid in a first azimuthal direction along the inner annulus to a first groove of the pair of grooves (e.g., stream 602 to groove 233), and distribute a second portion of the fluid in a second azimuthal direction, opposite the first direction, along the inner annulus to a second groove of the pair of grooves (e.g., stream 603 to groove 234). To illustrate, first azimuthal direction 610, second azimuthal direction 620, or both alternately, may correspond to a direction of rotation of the rotor (e.g., the rotor may spin either direction during operation).

In an illustrative example end ring 230 may be configured to distribute fluid in rotor 200. Catch basin 232 may be configured to receive fluid from rotor shaft 211, inner annulus 231 may extend in opposite directions from catch basin 232, and a pair of grooves (e.g., grooves 233 and 234) extend radially outward from inner annulus 231. Catch basin 232 may be located between the pair of grooves, and when end ring 230 is rotating (e.g., as rotor 200 is rotating), inner annulus 231 is configured to receive the fluid from catch basin 232 and direct the fluid to the pair of grooves.

As illustrated, end ring 230 includes sectors 401-404 (e.g., four quadrants, as illustrated) that are arranged about a center axis (e.g., axis 299 of FIG. 2), and catch basin 232 and grooves 233 and 234 are arranged in one sector (e.g., sector 401) of the four sectors. In some embodiments, grooves 233 and 234 are centered about catch basin 232. In some embodiments, catch basin 232 is centered with respect to feed port 213 such that feed port 213 is directed at the center of catch basin 232 (e.g., and grooves 233 and 234 may also be centered about feed port 213). In some embodiments, catch basin 232 may be substantially azimuthally centered about feed port 213 but offset from feed port 213 by a distance much less than half an azimuthal length of catch basin 232. In other embodiments, catch basin 232 may be azimuthally offset from feed port 213 by a distance up to half an azimuthal length of catch basin 232 (e.g., such that catch basin 232 just overlaps azimuthally with feed port 213).

In a further illustrative example, end ring 230 includes main body 235, which corresponds to the solid material that forms end ring 230 (e.g., into which recess features may be formed), which may include metal or composite materials, which may be formed using any suitable process (e.g., including casting, forging, machining or other process to form the solid features and recess features). End ring 230 has a ring shape (e.g., defined by main body 235), for example, extending around a center axis (e.g., axis 299) with two axial faces, a radially inner surface 245 (e.g., at a radially inward portion or end), and radially outer surface 246 (e.g., at a radially outward portion or end defined by the outer perimeter of end ring 230), with recess features extending into the ring shape (e.g., inner annulus 231, catch basin 232, grooves 233 and 234, ports, and any other suitable recess features). Inner annulus 231 is arranged at the radially inward portion (or end) of, and recessed into, main body 235 (e.g., around rotor shaft 211). For example, inner annulus 231 may include an inner annular surface that extends around rotor shaft 211 and defines an annular recess between rotor shaft 211 and end ring 230 (e.g., extending radially from rotor shaft 211 to radially inner surface 245 of end ring 230). To illustrate, inner annulus 231 does not extend fully through the thickness of end ring 230 in the axial direction (e.g., along axis 299) as some of the radially inward portion of end ring 230 engages rotor shaft 211 (e.g., radially inner surface 245 has an axial length less than an axial thickness of the ring shape of main body 235). The inner annular surface represents the outer boundary of inner annulus 231 in the radial direction (see, e.g., inner annulus 831 of FIG. 8). Catch basin 232 includes a volume that is recessed in an axial face of end ring 230 (e.g., a surface of main body 235) radially outward from inner annulus 231.

In a further illustrative example, end ring 230 includes a plurality of inlet ports, of which a pair of inlet ports (e.g., inlet ports 236 and 237) are coupled to a respective groove of the pair of grooves (e.g., grooves 233 and 234). In some embodiments, inlet ports 236 and 237 are arranged radially outward from catch basin 232, and grooves 233 and 234 accordingly extend radially outward to couple catch basin 232 to inlet ports 236 and 237. The pair of ports are configured to direct the fluid from the pair of grooves axially to cooling passages 260 of rotor 200. For example, in embodiments having four quadrants and four catch basins (e.g., of which catch basin 232 may be one), end ring 230 may provide fluid to eight cooling passages (e.g., cooling passages 260 may include two passages per catch basin and thus two passages per quadrant). In a further example, inlet ports 236 and 237 may each be an inlet slotted hole, or otherwise have any suitable shape. In some embodiments, the fluid that end ring 230 provides to substacks 212 (e.g., and magnets arranged therein) is a first stream received from a first set of feed ports of rotor shaft 211 (e.g., of which feed port 213 is one). In some such embodiments, outlet ports 238 and 239 extend axially through end ring 230 and are configured to direct a second stream from cooling passages 261 through end ring 230 and out of rotor 200. For example, inlet ports 236 and 237 may not extend axially through end ring 230, such that fluid is directed axially to cooling passages 260. Because the fluid from end ring 240 that flows through cooling passages 261 flows through end ring 230 and out of rotor 200, outlet ports 238 and 239 may include through holes. In an illustrative example, outlet ports 238 and 239 may each be an inlet slotted hole, or otherwise have any suitable shape, and may optionally have the same cross-sectional dimensions as inlet ports 236 and 237. In some embodiments, end rings 230 and 240 are configured to act in concert to provide axially counter flows of the fluid, through respective cooling passages 260 and 261, through substacks 212 of rotor 200 to cool magnets of rotor 200. In some embodiments, for example, a rotor includes M magnet pole-pairs where M is an even integer, the first end ring includes M/2 sectors of which the catch basin is arranged in a first sector, and the second end ring is clocked 360/M degrees relative to the first end ring (e.g., M may equal eight for rotor 200).

In some embodiments, as illustrated, end ring 230 includes a plurality of catch basins (e.g., of which, catch basin 232 is one) each having a respective volume recessed in main body 235 radially outward from an inner annular surface (e.g., of inner annulus 231). Each respective catch basin may be configured to receive fluid in the respective volume, direct a first portion of the fluid in a first azimuthal direction along the inner annular surface (e.g., stream 602 in first azimuthal direction 610), and direct a second portion of the fluid in a second azimuthal direction along the inner annular surface, opposite the first azimuthal direction (e.g., stream 603 in second azimuthal direction 620). In some embodiments, end ring 230 includes a plurality of grooves (e.g., of which grooves 233 and 234 are two) recessed in main body 235 that extend radially outward from the inner annular surface (e.g., of inner annulus 231). Each respective catch basin of the plurality of catch basins may be arranged between two respective grooves of the plurality of grooves. For example, catch basin 232 is arranged azimuthally between grooves 233 and 234. In some embodiments, each catch basin of the plurality of catch basins is configured to receive a respective portion of the fluid from rotor shaft 211 and split the respective portion among the two respective grooves (e.g., grooves 233 and 234 for catch basin 232). In an illustrative example, the plurality of catch basins includes N catch basins, where N is greater than two. The plurality of grooves may accordingly include 2N grooves (e.g., two grooves per catch basin, one on each side). To illustrate, in FIGS. 2-6, N is equal to four. In some embodiments, end ring 230 includes a plurality of inlet ports (e.g., of which inlet ports 236 and 237 are two) each coupled to a respective groove of the plurality of grooves (e.g., grooves 233 and 234). Each inlet port of the plurality of inlet ports may be configured to direct a respective portion of the fluid from the respective groove to a cooling passage of the rotor (e.g., cooling passages 260 of rotor 200).

In some embodiments, rotor 200 includes rotor shaft 211 having feed port 213 arranged in an outer surface of rotor shaft 211. For example, rotor 200 may include a plurality of feed holes (e.g., four of which are illustrated in FIG. 4, one in each of sectors 401-404), and end ring 230 may extend azimuthally around rotor shaft 211. In some embodiments, end ring 230 is a first end ring arranged at a first axial end of rotor 200 or otherwise substacks 212 thereof, and end ring 240 is a second end ring identical to end ring 230 and arranged at a second axial end of rotor 200 or substacks 212 thereof, opposite to the first axial end. The first end ring may be configured to provide the fluid to cooling passages 260 of rotor 200, and the second end ring may be configured to receive the fluid from cooling passages 260. In some embodiment, end ring 240 is clocked 45 degrees from end ring 230 as installed in rotor 200. Each of end rings 230 and 240 may include four quadrants arranged about axis 299, with each quadrant including a catch basin and a pair of grooves centered about the catch basin. More generally, an end ring may include N sectors, and a rotor may include two end rings at opposite axial ends of the substacks and facing each other that are clocked 180/N degrees from each other.

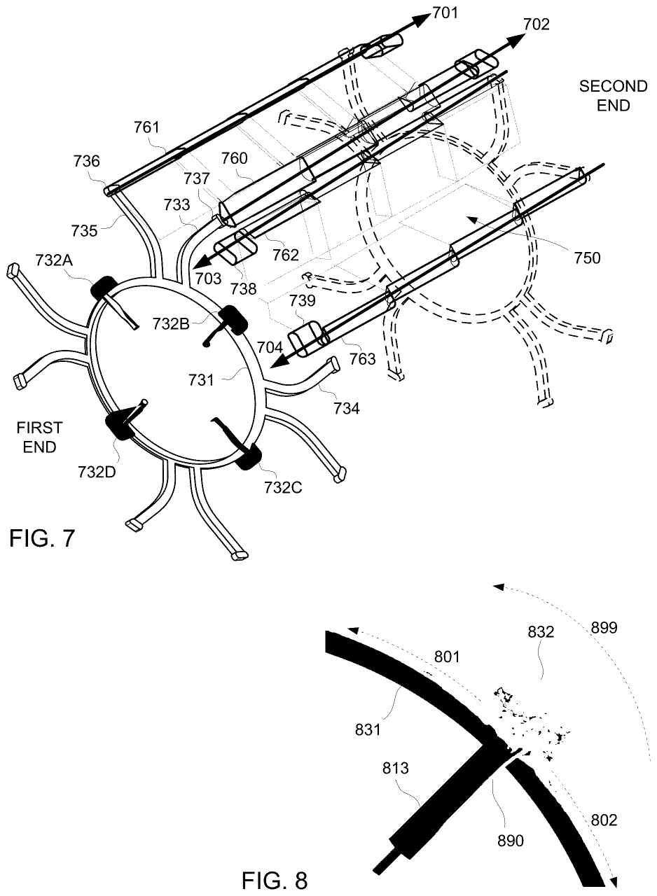

FIG. 7 shows a perspective view of illustrative flow paths in a rotor, in accordance with some embodiments of the present disclosure. FIG. 7 shows flow paths with most of the rotor removed for purposes of illustration, and a FIRST END and SECOND END of the rotor are indicated in FIG. 7 for reference. Fluid is provided to a rotor shaft and flows through feed ports, which may include a through hole, (e.g., as illustrated by feed port 213 in FIG. 4). For example, a fraction of the total flow into an end ring may flow into each of catch basins 732A, 732B, 732C, and 732D (e.g., via respective feed ports), each receiving about one fourth of the total flow. The fluid then flows from catch basins 732A, 732B, 732C, and 732D along inner annulus 731 in both first and second azimuthal directions. In some embodiments, the flow split from each of catch basins 732A, 732B, 732C, and 732D along inner annulus 731 is equal or about equal (e.g., a 50-50 split of the flow into each catch basin). The fluid then flows from inner annulus to grooves, of which there are two per catch basin. As illustrated, a portion of the flow into catch basin 732AB flows into groove 733 and another portion flows into groove 734. Similarly, groove 735 receives fluid from inner annulus 731 provided by catch basin 732A. The fluid in groove 735 flows through inlet port 736 and then through passage 761, exiting the rotor as stream 701, and the fluid in groove 733 flows through inlet port 737 and then through passage 760, exiting the rotor as stream 702 (e.g., as well as each groove in the end ring at the FIRST END). The end ring at the SECOND END may be clocked 45 degrees (e.g., 180/N degrees where N is equal to four) from end ring at the FIRST END. Flow from the end ring at the SECOND END flows to respective catch basins, an inner annulus, and grooves (e.g., two grooves per catch basin). For example, stream 703 flows from the end ring at the SECOND END, through passage 762, and out of outlet port 738 in the end ring at the FIRST END, and stream 704 flows from the end ring at the SECOND END, through passage 763, and out of outlet port 739 in the end ring at the FIRST END. While only four streams are illustrated in FIG. 7 (e.g., streams 701-704), each groove may be coupled to a respective passage and correspond to another stream. For example, half of the flow through the rotor may originate at each end ring, flow axially across the rotor (e.g., in suitable passages), and then flow out of the rotor at the opposite axial end from which it entered the rotor (e.g., the rotor includes cross-flowing passages). To illustrated, the rotor may include a plurality of magnets 750, installed in the substacks, and the fluid may flow through the substacks to cool the magnets (e.g., the passages are thermally coupled with the magnets, and the passages direct the flow to achieve heat transfer from the magnets to the fluid). For example, a rotor may include M magnet pole-pairs, 2M cooling passages (e.g., with flow in a first axial direction in M of the 2M passages, and flow in a second axial direction in the other M passages), and M/2 catch basins, and M grooves (e.g., M may equal eight, as illustrated in FIGS. 2-7, or any other suitable even integer).

FIG. 8 shows a cross-sectional view of illustrative catch basin 832 of an end ring, and a flow path, in accordance with some embodiments of the present disclosure. As illustrated, the end ring is installed in a rotor that is rotating in direction 899. Fluid stream 890 flows though feed hole 813, radially outward through inner annulus 831 (e.g., as a jet), and into catch basin 832. Fluid stream 890 fills catch basin 832, and flows out along inner annulus 831 in two azimuthal streams 801 (e.g., with direction 899) and 802 (e.g., against direction 899). As illustrated, fluid stream 890 may have a relatively greater velocity in the portion feed hole 813 nearer the back wall (e.g., the back wall in the context of direction 899), and may leave feed hole 813 as a jet from the rear portion. Catch basin 832 may provide a stagnation point or otherwise allow fluid stream 890 to accumulate and redirect, following the outer surface of inner annulus 831 both in direction 899 and the opposite direction. To illustrate, an end ring may include a plurality of catch basins (e.g., of which, catch basin 832 is one), and each catch basin may split a respective fluid stream in both azimuthal direction (e.g., with rotation and against rotation) along respective portions of inner annulus 831, which may correspond to sectors of the end ring.

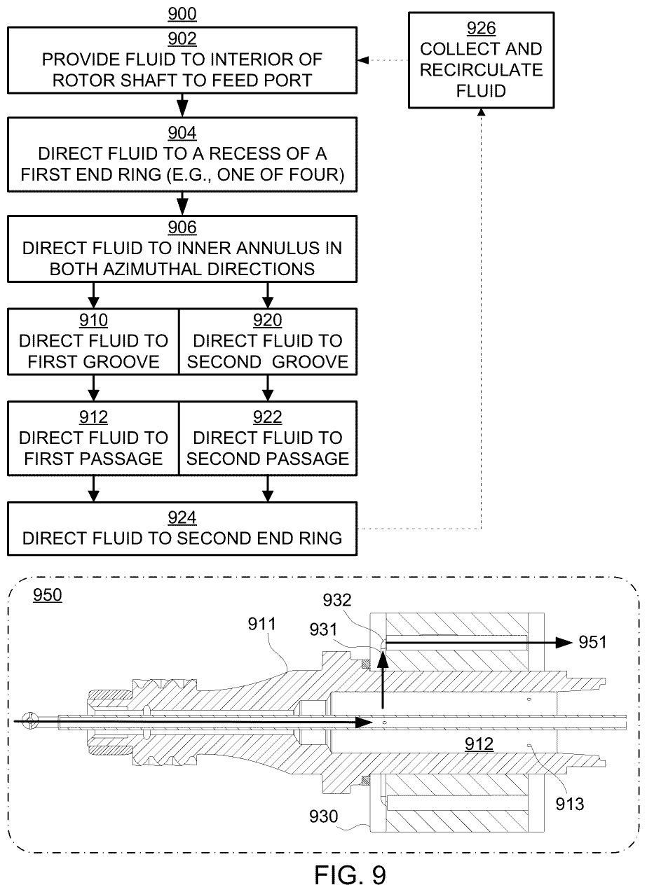

FIG. 9 is a flowchart of illustrative process 900 for directing flow 951 in a rotor, in accordance with some embodiments of the present disclosure. Panel 950 illustrates flow 951. Step 902 includes providing fluid to interior 912 of rotor shaft 911 to feed ports 913. Step 904 includes directing the fluid to recess 932 of first end ring 930. For example, recess 932 may be a catch basin, configured to receive the fluid from a feed port of feed ports 913. Step 906 includes directing the fluid to inner annulus 931, in both azimuthal directions (e.g., with and against a direction of rotation). Step 910 includes directing the fluid to a first groove, and step 920 includes directing fluid to a second groove. For example, step 910 may include directing a first portion of the fluid, step 920 may include directing a second portion of the fluid, and the first and second portions may be approximately equal or otherwise balanced. The first and second portions of the fluid may arise from the stream of fluid of steps 904 and 906. Step 912 includes directing the fluid to a first passage, and step 922 includes directing fluid to a second passage. The first and second passages may be cooling passages that extend axially through the rotor, to outlet ports on the opposite axial side of the rotor. Step 924 includes directing the fluid streams of steps 912 and 922 to a second end ring. For example, the second end ring is arranged at the opposite axial end of the rotor and includes outlet ports. Step 926 includes collecting and recirculating the fluid. For example, step 926 may include collecting the fluid in a basin or sump, and pumping back into rotor shaft 911 (e.g., repeating step 902).

The foregoing is merely illustrative of the principles of this disclosure and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

What is claimed is:

1. An end ring for distributing fluid in a rotor, comprising:
a catch basin configured to receive fluid from a rotor shaft;
an inner annulus extending in opposite directions from the catch basin; and
a pair of grooves extending radially outward from the inner annulus, wherein:
the catch basin is located between the pair of grooves; and
when the end ring is rotating, the inner annulus is configured to receive the fluid from the catch basin and direct the fluid to the pair of grooves.

2. The end ring of claim 1, wherein:
the inner annulus is arranged at a radially inward portion of the end ring around the rotor shaft; and
the catch basin comprises a volume extending radially outward from the inner annulus.

3. The end ring of claim 1, wherein the catch basin is configured to:
distribute a first portion of the fluid in a first azimuthal direction along the inner annulus to a first groove of the pair of grooves; and
distribute a second portion of the fluid in a second azimuthal direction, opposite the first direction, along the inner annulus to a second groove of the pair of grooves.

4. The end ring of claim 1, further comprising:
a pair of inlet ports each coupled to a respective groove of the pair of grooves, wherein the pair of inlet ports are configured to direct the fluid from the pair of grooves axially to cooling passages of the rotor.

5. The end ring of claim 4, wherein the fluid is a first stream, the end ring further comprising an outlet port extending axially through the end ring and configured to direct a second stream from the cooling passages and out of the rotor.

6. The end ring of claim 1, wherein:
the end ring comprises N sectors arranged about a center axis;
N is an integer greater than one;
the catch basin is arranged in one sector of the N sectors; and
the pair of grooves is arranged in the one sector and centered about the catch basin.

7. An end ring of a rotor, comprising:
a plurality of catch basins each comprising a respective volume extending radially outward from an inner annular surface, wherein each respective catch basin is configured to:
receive a fluid in the respective volume;
direct a first portion of the fluid in a first azimuthal direction along the inner annular surface; and
direct a second portion of the fluid in a second azimuthal direction along the inner annular surface, opposite the first azimuthal direction.

8. The end ring of claim 7, further comprising:
a plurality of grooves extending radially outward from the inner annular surface, wherein each respective catch basin of the plurality of catch basins is arranged between two respective grooves of the plurality of grooves.

9. The end ring of claim 8, wherein each catch basin of the plurality of catch basins is configured to receive a respective portion of the fluid from a rotor shaft and split the respective portion among the two respective grooves.

10. The end ring of claim 8, wherein:
the plurality of catch basins comprises N catch basins, wherein N is greater than two; and
the plurality of grooves comprises 2N grooves.

11. The end ring of claim 8, further comprising:
a plurality of inlet ports each coupled to a respective groove of the plurality of grooves and configured to direct a respective portion of the fluid from the respective groove to a cooling passage of the rotor.

12. The end ring of claim 7, wherein the fluid is a first stream, the end ring further comprising a plurality of outlet ports extending axially through the end ring and configured to interface to cooling passages of the rotor to direct a second stream from the cooling passages through the end ring and out of the rotor.

13. The end ring of claim 7, wherein the first azimuthal direction corresponds to a direction of rotation of the rotor.

14. The end ring of claim 7, comprising a radially inward end and a radially outward end, and wherein the inner annular surface is arranged at the radially inward end.

15. The end ring of claim 7, wherein:
the end ring comprises four quadrants arranged about a center axis;
the plurality of catch basins consists of four catch basins; and
each catch basin of the four catch basins is arranged in a respective quadrant.

16. A rotor comprising:
a rotor shaft comprising a feed port arranged in an outer surface; and
an end ring extending around the rotor shaft and comprising:
a catch basin configured to receive fluid from the feed port;
an inner annulus extending in opposite directions from the catch basin; and
a pair of grooves extending radially outward from the inner annulus, wherein:
the catch basin is located between the pair of grooves; and
when the rotor is rotating, the inner annulus is configured to receive the fluid from the catch basin and direct the fluid to the pair of grooves.

17. The rotor of claim 16, wherein:
the inner annulus is arranged at a radially inward portion of the end ring around the rotor shaft; and
the catch basin comprises a volume extending radially outward from the inner annulus.

18. The rotor of claim 16, wherein the end ring is a first end ring arranged at a first axial end of the rotor, further comprising:
a second end ring identical to the first end ring and arranged at a second axial end of the rotor, opposite to the first axial end, wherein the first end ring is configured to provide the fluid to cooling passages of the rotor, and wherein the second end ring is configured to receive the fluid from the cooling passages.

19. The rotor of claim 18, wherein:
the rotor comprises M magnet pole-pairs;
M is an even integer;
the first end ring comprises M/2 sectors of which the catch basin is arranged in a first sector; and
the second end ring is clocked 360/M degrees relative to the first end ring.

20. The rotor of claim 16, wherein:
the end ring comprises N sectors arranged about a center axis;
N is an integer greater than one;
the catch basin is arranged in one sector of the N sectors; and
the pair of grooves is arranged in the one sector and centered about the catch basin.
